(19) United States
(12) Patent Application Publication
(10) Pub. No.: US 2026/0287889 A1
(43) Pub. Date: Sep. 24, 2026

(54) PICTURE GENERATION UNIT FOR HEAD-UP DISPLAY AND MOVING OBJECT INCLUDING THE SAME

(71) Applicant: HYUNDAI MOBIS CO., LTD., Seoul (KR)

(72) Inventor: Hyun Woo KANG, Yongin-si (KR)

(73) Assignee: HYUNDAI MOBIS CO., LTD., Seoul (KR)

(21) Appl. No.: 19/414,435

(22) Filed: Dec. 10, 2025

(30) Foreign Application Priority Data
Mar. 24, 2025 (KR) 10-2025-0037470

(51) Int. Cl. G02B 27/01; G02F 1/1335; G02F 1/13357

(52) U.S. Cl. CPC G02B 27/0101; G02B 27/0149; G02F 1/133603; G02F 1/133605; G02F 1/133606; G02F 1/133628; G02B 2027/013; G02B 2027/0152

(57) ABSTRACT

A picture generation unit, a moving object having a head-up display that includes the picture generation unit, and a picture generation system are provided. The picture generation unit includes a light source module including light source elements and a circuit board having the light source elements disposed thereon, a reflector coupled to the circuit board, a diffuser for diffusing light emitted from the light source elements, and a liquid crystal display (LCD) for generating an image based on the light emitted from the light source that passed through the diffuser. The reflector includes a reflective surface formed with multiple facets.

### CROSS-REFERENCE TO RELATED APPLICATION(S)

This application claims the benefit under 35 USC § 119(a) of Korean Patent Application No. 10-2025-0037470, filed on Mar 24, 2025, in the Korean Intellectual Property Office, the entire disclosure of which is hereby incorporated by reference for all purposes.

### BACKGROUND

### 1. Field

The present disclosure relates to a picture generation unit for head-up displays, a head-up display device including the same, and a moving object including the same.

### 2. Description of the Related Art

A head-up display (HUD) is a device that projects driving-related information onto the front windshield of a vehicle or a separate transparent screen to allow a driver to view the information without lowering the head or diverting the gaze. The HUD is becoming increasingly important as a technology for enhancing driving safety and efficiently providing visual information during driving.

One of the key components of the HUD is a picture generation unit (PGU). The PGU generates digital images or videos and projects the digital images or videos onto the front windshield or a combiner through an optical system. The PGU mainly generates images based on a liquid crystal display (LCD) panel, a digital light processing (DLP) module, or a liquid crystal on silicon (LCoS) technology.

The internal structure of the PGU is precisely designed in consideration of thermal management and optical efficiency. In particular, the PGU includes a thermal interface material (TIM) for heat dissipation, a funnel for condensing light from a light source, a diffuser for ensuring uniformity of light, and an LCD for outputting an actual image. These components are organically combined to generate high-brightness and high-contrast images, thereby enabling a user to clearly view driving information.

Recently, with the advancement of vehicle sophistication and electronic equipment, the resolution, projection distance, and brightness of the HUD have been improved, and research and development of augmented reality head-up displays (AR-HUDs) incorporating AR functions are actively being conducted. Accordingly, the performance of the PGU has also become more sophisticated, and various technologies have been introduced to optimize optical design and thermal management.

Based on the above background, the present disclosure aims to address technical challenges to enhance the performance of a PGU and improve the projection quality of a HUD.

### SUMMARY

Accordingly, the present disclosure is directed to a picture generation unit for a head-up display and a moving object including the same that substantially obviate one or more problems due to limitations and disadvantages of the related art.

In accordance with the above-described background, the present disclosure aims to provide a picture generation unit (PGU) for head-up displays (HUDs).

Specifically, the present disclosure aims to provide a PGU having a structure designed to reduce manufacturing cost and weight.

In addition, the present disclosure aims to provide PGU that ensures heat dissipation performance and brightness uniformity.

The objectives of the present disclosure are not limited to those described above. Other objectives not described above will be understood by those skilled in the art from the following description of the present disclosure.

In a general aspect, a picture generation unit includes: a light source module including a plurality of light source elements, and a circuit board having the plurality of light source elements disposed thereon; a reflector coupled to the circuit board; a diffuser configured to diffuse light emitted from the light source elements; and a liquid crystal display (LCD) configured to generate an image based on the light emitted from the light source that passed through the diffuser, wherein the reflector includes a reflective surface formed with multiple facets.

The reflector may include a plurality of regions respectively corresponding to the plurality of light source elements.

Each of the plurality of regions may include a first sub-region and a second sub-region, wherein multiple facets of the first sub-region may be formed with fields of view (FOVs) within a first range of angles, and wherein multiple facets of the second sub-region may be formed with FOVs within a second range of angles.

The multiple facets of the first sub-region may diffuse light reflected by the reflective surface, wherein the multiple facets of the second sub-region may improve luminance of the light reflected by the reflective surface.

The light source module may include three light source elements, wherein an interval between the respective light source elements may be set to be greater than or equal to 10 mm.

The three light source elements may be arranged to have a same minimum distance to the reflective surface of the reflector, wherein the minimum distance may be set to be greater than or equal to 10 mm.

The reflector may further include a secondary reflective surface, wherein the secondary reflective surface may be configured to reflect light reflected from the multiple facets.

The secondary reflective surface may be positioned below an end portion of the circuit board.

The circuit board may include a multilayer FR-4 printed circuit board (PCB), wherein the circuit board may have a predetermined size or a predetermined number of via holes.

In another general aspect, a moving object having a head-up display, includes: a case for the head-up display; and a picture generation unit assembled to the case, wherein the picture generation unit includes a light source module including a plurality of light source elements and a circuit board having the plurality of light source elements disposed thereon; a reflector coupled to the circuit board; a diffuser configured to diffuse light emitted from the light source elements; and a liquid crystal display configured to generate an image based on the light emitted from the light source that passed through the diffuser, wherein the reflector includes a reflective surface formed with multiple facets.

In yet another general aspect, a picture generation system includes: a light source module including a circuit board and a plurality of light source elements disposed on the circuit board; a reflector coupled to the circuit board; a diffuser configured to diffuse light emitted from the light source elements; a liquid crystal display (LCD); a controller configured to control the LCD to generate an image based on the light emitted from the light source that passed through the diffuser, wherein the reflector includes a reflective surface formed with multiple facets.

The reflector may include a plurality of regions respectively corresponding to the plurality of light source elements.

Each of the plurality of regions may include a first sub-region and a second sub-region, wherein multiple facets of the first sub-region may be formed with fields of view (FOVs) within a first range of angles, and wherein multiple facets of the second sub-region may be formed with FOVs within a second range of angles.

The multiple facets of the first sub-region may diffuse light reflected by the reflective surface, wherein the multiple facets of the second sub-region may be configured to improve luminance of the light reflected by the reflective surface.

The light source module may include three light source elements, wherein an interval between the respective light source elements may be set to be greater than or equal to 10 mm.

The three light source elements may be arranged to have a same minimum distance to the reflective surface of the reflector, wherein the minimum distance may be set to be greater than or equal to 10 mm.

The reflector may further include a secondary reflective surface, wherein the secondary reflective surface may be configured to reflect light reflected from the multiple facets.

The secondary reflective surface may be positioned below an end portion of the circuit board.

The circuit board may include a multilayer FR-4 printed circuit board (PCB), wherein the circuit board may have a predetermined size or a predetermined number of via holes.

The above-described solution means of the present disclosure are part of the embodiments of the present disclosure. Various other solution means for the above-described problems may be derived and understood based on the detailed description of the present disclosure set forth below.

The present disclosure has the following effects.

According to the present disclosure, since a separate heat sink is not required, the weight may be reduced and the manufacturing cost may be lowered.

In addition, according to the present disclosure, it is possible to maintain the uniformity of light brightness while reducing the number of light sources.

The effects of the present disclosure are not limited to those described above. Other effects not described above will be understood by those skilled in the art from the following description of the present disclosure.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is an exploded perspective view illustrating a conventional picture generation unit;

FIG. 2 is an exploded perspective view illustrating a picture generation unit according to the present disclosure;

FIG. 3 illustrates optical characteristics of a picture generation unit according to the present disclosure;

FIG. 4 illustrates optical characteristics of a picture generation unit according to the present disclosure;

FIG. 5 illustrates temperature variation information according to characteristics of a circuit board of a picture generation unit according to the present disclosure;

FIG. 6 illustrates a front view of an assembly of a reflector and a light source module of a picture generation unit according to the present disclosure;

FIG. 7 illustrates a perspective view of an assembly of a reflector and a light source module of a picture generation unit according to the present disclosure;

FIG. 8 illustrates a side cross-sectional view of an assembly of a reflector and a light source module of a picture generation unit according to the present disclosure;

FIG. 9 illustrates a light source module, a reflector, and a coupling state thereof in a picture generation unit according to the present disclosure; and

FIG. 10 illustrates a state in which a picture generation unit according to the present disclosure is coupled to a head-up display case.

### DETAILED DESCRIPTION

Hereinafter, embodiments of the present invention will be described with reference to the accompanying drawings.

The embodiments described below are provided for purposes of understanding the present invention, and thus the present invention is not limited to the embodiments set forth herein. In the accompanying drawings, certain components may be illustrated in an exaggerated or reduced scale for clarity of the invention. The present invention is not limited to the shapes or arrangements shown in the drawings.

Throughout this specification, when a part is described as “including” a certain component, this means that the part may further include one or more additional components, unless expressly stated otherwise, rather than excluding other components.

Further, in the specification, terms such as “occupant,” “driver,” or “user” may be used for the purpose of explaining the invention, and such terms may be used interchangeably.

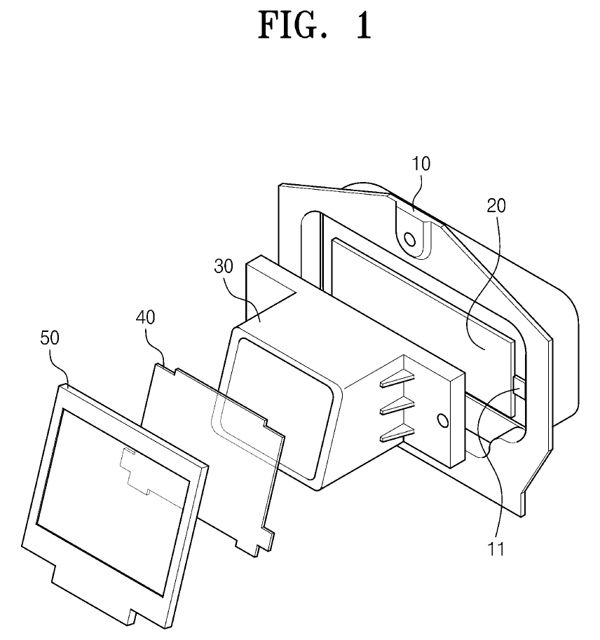

FIG. 1 is an exploded perspective view illustrating a conventional picture generation unit.

The picture generation unit may include a heat sink 10, a thermal interface material (TIM) 11, a light source module 20, a funnel 30, a diffuser 40, and a liquid crystal display (LCD) 50.

The heat sink 10 may include an accommodation space therein. The heat sink 10 may be configured to accommodate the light source module 20, the funnel 30, and the like. The heat sink 10 may be disposed behind the light source module 20. The heat sink 10 may be configured to dissipate heat generated from the light source module 20 and/or heat inside the picture generation unit to the outside.

The light source module 20 may include a circuit board such as a printed circuit board (PCB) and a light source. The light source, as a member for emitting light, may be disposed on the circuit board. The light source may include a plurality of light source elements, and the light source may be a light emitting diode (LED). The plurality of light source elements may be arranged on the circuit board in a predetermined pattern. Light emitted from the light source may pass through the funnel 30 and the diffuser 40 and may be incident on the rear side of the LCD 50.

The funnel 30 may be disposed in front of the light source module 20 where the light source is disposed. The funnel 30 may be disposed behind the LCD 50 and the diffuser 40. The funnel 30 guides a traveling path of light emitted from the light source such that the light is uniformly incident on the diffuser 40 and the LCD 50. To guide the traveling path of the light emitted from the light source, the inside of the funnel 30 may have a cup shape.

The diffuser 40 is disposed behind the LCD 50. The diffuser 40 may be disposed between the funnel 30 and the LCD 50. A plurality of diffusers 230 may be provided. The diffuser 230 diffuses light emitted from the light source such that the light is evenly incident on the rear side of the LCD 50. The diffuser 40 may be manufactured in a shape and size corresponding to at least a portion of the LCD 50.

The LCD 50 emits an image using light emitted from the light source.

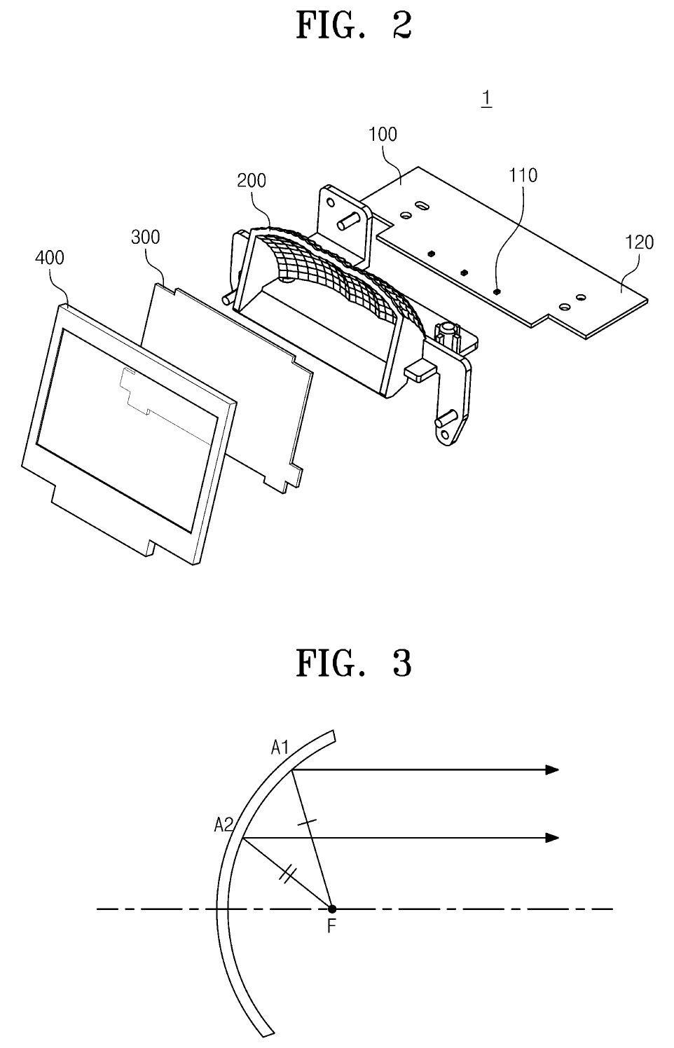

FIG. 2 is an exploded perspective view illustrating a picture generation unit according to the present disclosure.

The picture generation unit 1 according to the present disclosure may be configured to include a light source module 100, a reflector 200, a diffuser 300, and an LCD 400.

The picture generation unit 1 according to the present disclosure is configured to reduce manufacturing cost or weight compared to a conventional picture generation unit. In addition, although the picture generation unit 1 according to the present disclosure is designed for cost and weight reduction, the picture generation unit 1 is configured to include an optical system capable of maintaining the brightness performance of light imaged onto the LCD through the diffuser.

The light source module 100 may be configured to include a plurality of light source elements 110 and a circuit board 120 on which the plurality of light source elements are disposed. The light source elements may be LEDs or micro-LEDs. The light source elements may be arranged on the circuit board 120 in a predetermined pattern.

The circuit board 120 includes a PCB and may be of an FR-4 type. In addition, the circuit board 120 may include a multilayer FR-4 PCB having enhanced heat dissipation performance to replace a heat sink.

The reflector 200 reflects light emitted from the light source elements such that the light is incident on the diffuser. A reflective surface of the reflector 200 includes multiple facets or is configured to be formed with multiple facets. In addition, the reflector 200 may be configured to include reflection regions respectively corresponding to the plurality of light source elements 110 of the light source module 100. This will be described in detail later.

FIG. 3 illustrates optical characteristics of the reflector 200 of the picture generation unit 1 according to the present disclosure.

Referring to FIG. 3, a cross-sectional contour of the reflector 200 is illustrated as a parabola, and light emitted from a focal point F of the parabola is reflected at points A1 and A2, respectively, and then travels in parallel. This is due to the characteristics of the parabola.

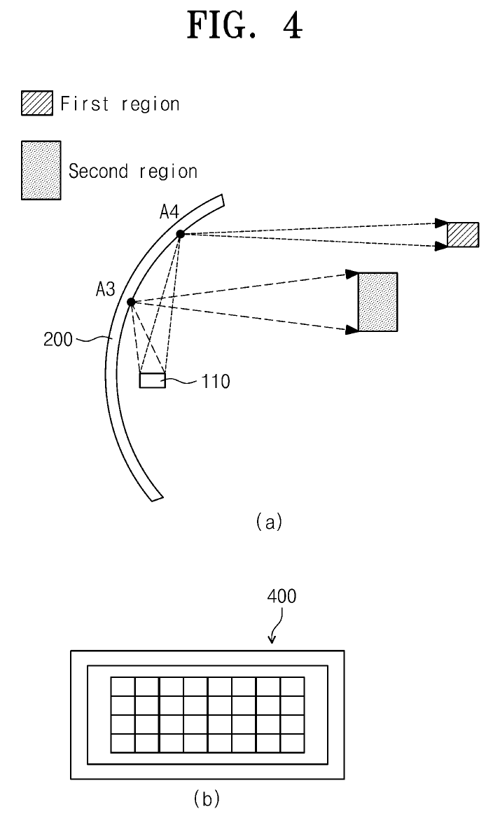

FIG. 4 illustrates optical characteristics of the reflector 200 of the picture generation unit 1 according to the present disclosure. As shown in FIG. 4, part (a), the reflector 200 is designed to have different fields of view depending on the position thereof. Thus, light reflected at points A3 and A4 is directed toward different regions, and the sizes of the regions may be formed to be different.

A first region, that is, a central portion of the reflector 200, has a relatively large diffusion angle, and accordingly, the beam spread of light reflected therefrom is relatively large. A second region, that is, an outer portion of the reflector 200, may have a relatively small diffusion angle, and accordingly, the beam spread of light reflected therefrom may be relatively small.

FIG. 4, part (b), illustrates the beam spread formed on the LCD 400 according to the optical characteristics of the reflector 200 shown in FIG. 4, part (a).

The design of the diffusion angle according to the reflection regions of the reflector shown in FIG. 4 is intended to make the brightness distribution of light as uniform as possible. Accordingly, the central portion of the reflective surface of the reflector is configured to have a relatively large diffusion angle such that the reflected light is capable of being widely diffused. In addition, the outer portion of the reflective surface of the reflector is configured to have a relatively small diffusion angle such that the reflected light is capable of being narrowly concentrated.

The diffuser 300 may be disposed in front of the reflector 200 and behind the LCD 400. The diffuser 300 diffuses light emitted from the light source elements 110 such that the light is evenly incident on the rear side of the LCD 400. The LCD 400 is configured to generate an image using light emitted from the light source elements 110. That is, a controller (e.g., processor) may be configured to control the LCD 400 to generate the image.

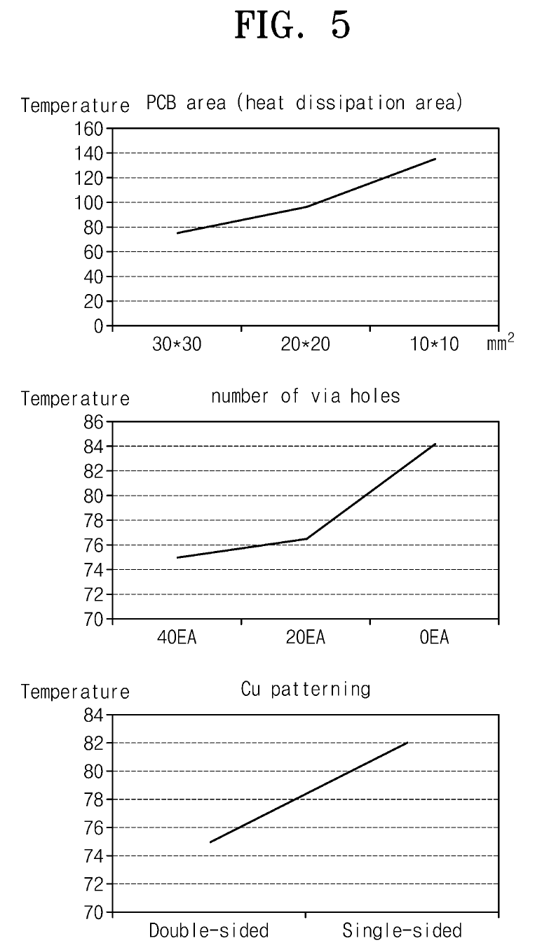

FIG. 5 illustrates temperature variation information according to the characteristics of the circuit board of the picture generation unit according to the present disclosure.

As described above, the circuit board 120 of the light source module 100 may be implemented as a multilayer FR-4 PCB. This is to enhance heat dissipation performance since the picture generation unit 1 of the present disclosure does not include a separate heat sink.

The heat dissipation performance of the picture generation unit 1 is intended to maintain the junction temperature (Tj) of an LED 110 at an appropriate level. The junction temperature refers to a temperature generated at a semiconductor junction inside an LED chip, which directly affects the performance, lifespan, and luminous efficiency of the LED. For example, when the junction temperature increases, the external luminance (luminous flux) of the LED decreases. That is, optical output is reduced. In addition, as the junction temperature increases, the emission wavelength shifts toward the red direction, which causes a change in the color of the light. In addition, the higher the junction temperature, the faster the semiconductor deterioration occurs, which shortens the lifespan of the LED. Therefore, it is necessary to maintain the junction temperature at an appropriate level.

For example, the target temperature for heat dissipation performance may be set such that when the ambient temperature (Ta) is 25°C, the junction temperature is 75°C or lower, and when the ambient temperature is 85°C, the junction temperature is 135°C or lower.

FIG. 5 illustrates experimental results for testing heat dissipation performance. FIG. 5 shows the results according to the area of the circuit board 120, the number of via holes formed in the circuit board 120, and the number of layers (Cu patterning count).

Referring to FIG. 5, it is confirmed that as the area of the circuit board 120 decreases, or as the number of via holes decreases, or as the number of layers decreases, the junction temperature increases.

Accordingly, the circuit board 120 of the present disclosure may be configured such that the number of via holes is equal to or greater than a predetermined number and the area has a predetermined size. For example, the circuit board 120 of the present disclosure may be configured to have 40 or more via holes and an area of 30*30 mm² or greater. In addition, the circuit board 120 of the present disclosure may be configured to have multiple layers (two layers), that is, two Cu patterning layers.

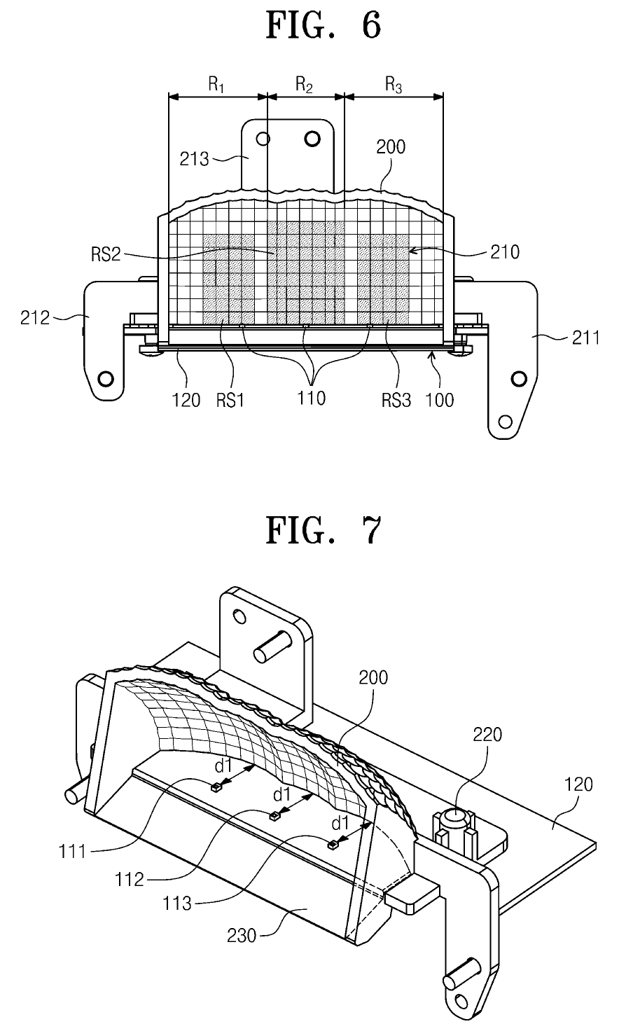

FIG. 6 is a front view illustrating an assembly of the reflector and the light source module of the picture generation unit according to the present disclosure.

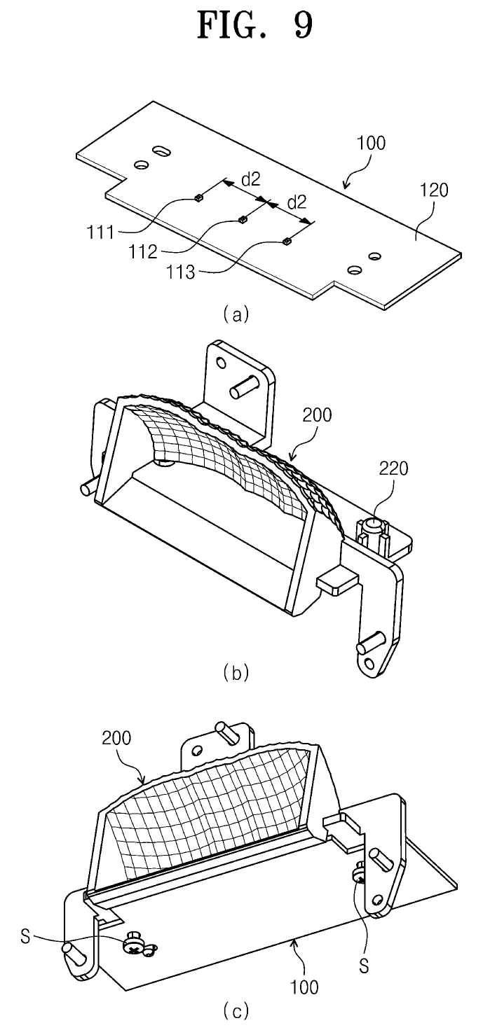

The reflector 200 and the light source module 100 may be assembled or coupled to each other through a coupling portion (not shown). Accordingly, the reflector 200 of the present disclosure includes, on the rear side thereof, a coupling portion for coupling with the circuit board 120, and a screw is fastened to the coupling portion such that the circuit board 120 or the light source module 100 is assembled with the reflector 200. The assembled state of the light source module 100 and the reflector 200 is illustrated more clearly in FIG. 9, part (c).

The reflector 200 of the present disclosure may be configured to have a reflective surface 210 formed with multiple facets. Through the multiple facets, the diffusion angle of the reflective surface of the reflector 200 described above may be configured or controlled.

The reflector 200 of the present disclosure may be formed in a symmetrical shape with respect to the center thereof.

The reflector 200 of the present disclosure may be configured with a plurality of regions R1, R2, and R3 respectively corresponding to the light source elements 110. In addition, the reflector 200 of the present disclosure may be configured with a plurality of reflective surface regions respectively corresponding to the light source elements 110.

In addition, each reflective surface region may be composed of a first sub-region and a second sub-region. The first sub-region and the second sub-region may be distinguished by fields of view of the multiple facets.

The multiple facets of the first sub-region are formed with fields of view within a first range of angles, and the multiple facets of the second sub-region are formed with fields of view within a second range of angles. For example, the first range of angles may be between 15 degrees and 20 degrees, and the second range of angles may be less than 10 degrees.

That is, as shown in FIG. 6, central portions of each reflective surface region may be set as first sub-regions RS1, RS2, and RS3 and may be formed with multiple facets for diffusion of reflected light. Second sub-regions of each reflective surface region may be formed with multiple facets for concentration of reflected light or improvement of luminance.

In addition, the reflector 200 of the present disclosure may include fastening portions 211, 212, and 213 on the upper side thereof and both lateral sides. The fastening portions 211, 212, and 213 may be fastened to a moving object or a case of a head-up display. The reflector 200 or the picture generation unit 1 including the reflector may be assembled to the vehicle or the case of the head-up display by fastening screws into holes of the fastening portions.

FIG. 7 is a perspective view illustrating an assembly of the reflector and the light source module of the picture generation unit according to the present disclosure.

The reflector 200 may be configured to further include a secondary reflective surface 230. The secondary reflective surface 230 may be configured to reflect light that is reflected by the multiple facets of the reflective surface of the reflector 200. Thus, the luminance of the reflected light may be improved.

The secondary reflective surface 230 may be positioned below an end portion of the circuit board 120 of the light source module.

In addition, the minimum distance (focal distance) from the reflective surface formed with the multiple facets of the reflector 200 to each of light source elements 111, 112, and 113 may be configured to have a predetermined distance d1. In this case, d1 may be set to 10 mm or greater.

In another example, the central light source element 112 may be configured to have a distance d11 from the reflective surface formed with the multiple facets, and the remaining two light source elements 111 and 113 may be configured to have a distance d12 from the reflective surface. In this case, d11 and d12 may be different from each other, and d11 and d12 may be set to 10 mm or greater.

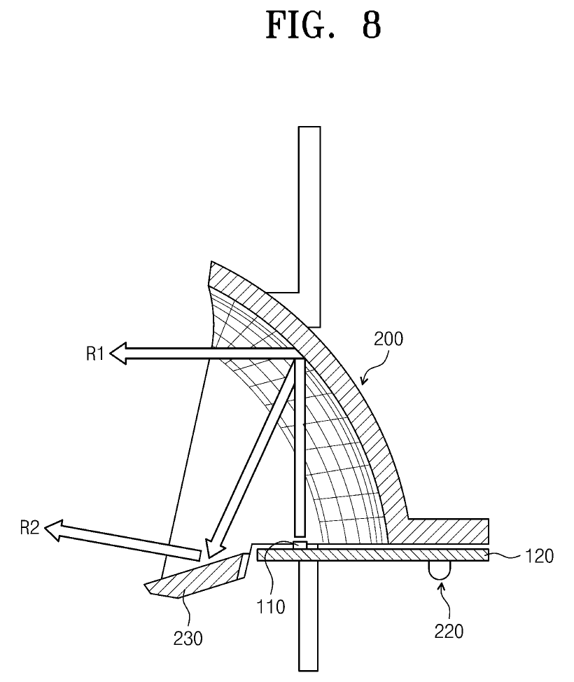

FIG. 8 is a side cross-sectional view illustrating an assembly of the reflector and the light source module of the picture generation unit according to the present disclosure.

As shown in FIG. 8, since light R2 reflected by the secondary reflective surface 230 is incident on the diffuser 300, thereby achieving luminance improvement.

FIG. 9 illustrates the light source module, the reflector, and a coupled state thereof of the picture generation unit according to the present disclosure.

FIG. 9, part (a) illustrates the light source module 100. The light source elements 110 are disposed on the circuit board 120.

Each light source element may be disposed at a predetermined distance from an end of the circuit board 120. Referring to FIG. 9, part (a), it is illustrated that three light source elements 110 are disposed on the circuit board 120, and each light source element is arranged at the same interval d1. In this case, the arrangement interval d1 between the light source elements may be set to 10 mm or greater.

FIG. 9, part (b), shows a coupling portion 220 of the reflector 200. A screw is fastened to the 230220 of the reflector 200 such that the circuit board 120 or the light source module 100 is assembled with the reflector 200.

FIG. 9, part (c), shows a state in which the light source module 100 and the reflector 200 are assembled together. FIG. 9, part (c), shows that the circuit board 120 or the light source module 100 is assembled with the reflector 200 by a screw S.

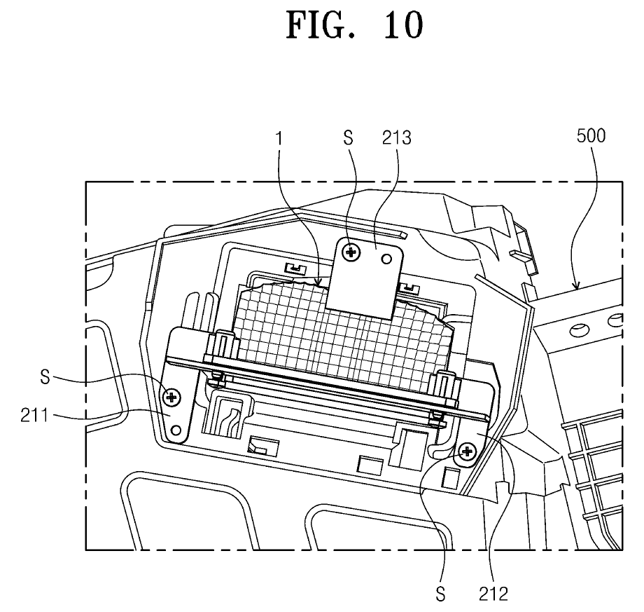

FIG. 10 illustrates a state in which the picture generation unit according to the present disclosure is coupled to a head-up display case.

As described above, it is illustrated that screws are fastened to the fastening portions 211, 212, and 213 of the reflector 200, and the picture generation unit 1 or the reflector 200 is coupled or assembled to a case 500 of the head-up display.

As another embodiment of the present disclosure, a moving object or vehicle 1000 including the picture generation unit 1, the assembly of the reflector 200 and the light source module 100, or the head-up display including the components is proposed. Such a moving object or vehicle may also fall within the scope of the present disclosure.

The detailed description of the preferred embodiments of the present disclosure as set forth above has been provided to enable those of ordinary skill in the art to implement and practice the present disclosure.

Although the present disclosure has been described above with reference to preferred embodiments thereof, it will be understood by those of ordinary skill in the art that various modifications and changes of the present disclosure may be made within the scope of the following claims.

Accordingly, the present disclosure is not intended to be limited to the embodiments shown herein but is to be accorded the widest scope consistent with the principles and novel features disclosed herein.

What is claimed is:

1. A picture generation unit comprising:
a light source module comprising:
a plurality of light source elements; and
a circuit board having the plurality of light source elements disposed thereon;
a reflector coupled to the circuit board;
a diffuser configured to diffuse light emitted from the light source elements; and
a liquid crystal display (LCD) configured to generate an image based on the light emitted from the light source that passed through the diffuser,
wherein the reflector comprises a reflective surface formed with multiple facets.

2. The picture generation unit of claim 1, wherein the reflector comprises a plurality of regions respectively corresponding to the plurality of light source elements.

3. The picture generation unit of claim 2, wherein each of the plurality of regions comprises a first sub-region and a second sub-region,
wherein multiple facets of the first sub-region are formed with fields of view (FOVs) within a first range of angles, and
wherein multiple facets of the second sub-region are formed with FOVs within a second range of angles.

4. The picture generation unit of claim 3, wherein the multiple facets of the first sub-region diffuse light reflected by the reflective surface, and
wherein the multiple facets of the second sub-region improve luminance of the light reflected by the reflective surface.

5. The picture generation unit of claim 1, wherein the light source module comprises three light source elements, and
wherein an interval between the respective light source elements is set to be greater than or equal to 10 mm.

6. The picture generation unit of claim 5, wherein the three light source elements are arranged to have a same minimum distance to the reflective surface of the reflector, and
wherein the minimum distance is set to be greater than or equal to 10 mm.

7. The picture generation unit of claim 1, wherein the reflector further comprises a secondary reflective surface, and
wherein the secondary reflective surface is configured to reflect light reflected from the multiple facets.

8. The picture generation unit of claim 7, wherein the secondary reflective surface is positioned below an end portion of the circuit board.

9. The picture generation unit of claim 1, wherein the circuit board comprises a multilayer FR-4 printed circuit board (PCB), and
wherein the circuit board has a predetermined size or a predetermined number of via holes.

10. A moving object having a head-up display, the moving object comprising:
a case for the head-up display; and
a picture generation unit assembled to the case,
wherein the picture generation unit comprises:
a light source module comprising:
a plurality of light source elements; and
a circuit board having the plurality of light source elements disposed thereon;
a reflector coupled to the circuit board;
a diffuser configured to diffuse light emitted from the light source elements; and
a liquid crystal display configured to generate an image based on the light emitted from the light source that passed through the diffuser,
wherein the reflector comprises a reflective surface formed with multiple facets.

11. A picture generation system comprising:
a light source module including:
a circuit board; and
a plurality of light source elements disposed on the circuit board;
a reflector coupled to the circuit board;
a diffuser configured to diffuse light emitted from the light source elements;
a liquid crystal display (LCD);
a controller configured to control the LCD to generate an image based on the light emitted from the light source that passed through the diffuser,
wherein the reflector comprises a reflective surface formed with multiple facets.

12. The picture generation system of claim 11, wherein the reflector comprises a plurality of regions respectively corresponding to the plurality of light source elements.

13. The picture generation system of claim 12, wherein each of the plurality of regions comprises a first sub-region and a second sub-region,
wherein multiple facets of the first sub-region are formed with fields of view (FOVs) within a first range of angles, and
wherein multiple facets of the second sub-region are formed with FOVs within a second range of angles.

14. The picture generation system of claim 13, wherein the multiple facets of the first sub-region diffuse light reflected by the reflective surface, and
wherein the multiple facets of the second sub-region are configured to improve luminance of the light reflected by the reflective surface.

15. The picture generation system of claim 11, wherein the light source module comprises three light source elements, and
wherein an interval between the respective light source elements is set to be greater than or equal to 10 mm.

16. The picture generation system of claim 15, wherein the three light source elements are arranged to have a same minimum distance to the reflective surface of the reflector, and
wherein the minimum distance is set to be greater than or equal to 10 mm.

17. The picture generation system of claim 11, wherein the reflector further comprises a secondary reflective surface, and
wherein the secondary reflective surface is configured to reflect light reflected from the multiple facets.

18. The picture generation system of claim 17, wherein the secondary reflective surface is positioned below an end portion of the circuit board.

19. The picture generation system of claim 11, wherein the circuit board comprises a multilayer FR-4 printed circuit board (PCB), and
wherein the circuit board has a predetermined size or a predetermined number of via holes.
